(19) United States
(12) Patent Application Publication
(10) Pub. No.: US 2006/0011889 A1
(43) Pub. Date: Jan. 19, 2006

(54) Semiconducting compositions comprising guest material and organic light emitting host material, methods for preparing such compositions, and devices made therewith

(76) Inventors: Yong Cao, Goleta, CA (US); Gang Yu, Santa Barbara, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/890,359

(22) Filed: Jul. 13, 2004

(51) Int. Cl. C09K 11/06; H05B 33/14

(52) U.S. Cl. 252/301.16; 428/690; 428/917; 313/504; 313/506; 257/40; 257/102; 257/103; 257/E51.028; 257/E51.036; 252/301.35

(57) ABSTRACT

The present invention is generally directed to semiconducting compositions containing a guest material and a light emitting organic host material. These compositions are useful for color tuning and improving efficiency in an electroluminescent device. It further relates to a process for preparing the compositions and the layers and devices that are made with the compositions.

### FIELD OF THE INVENTION

This invention relates to semiconductor compositions having a guest material and a light emitting organic host material, and to methods for producing such compositions. These compositions are useful for color tuning and improving efficiency in an electroluminescent device. The invention further relates to semiconductor devices in which the light-emitting layer is comprised of one or more layers, at least one of which includes such semiconductor compositions.

### BACKGROUND INFORMATION

Light-emitting diodes (LEDs) are useful in display devices. The light-emitting layer in a LED emits light through a transparent or semitransparent contact layer upon application of electricity across the electrical contact layers of the device. The colors of light emitted by a LED or device containing a LED are highly dependent upon the type of light emitting materials used. Full color displays typically require red, green, and blue light emission.

The optical and electrical properties of the traditional inorganic crystalline semiconductors used in LEDs, including bandgap, electron affinity, conductivity, mobility, and surface properties, are limited in that they can adopt only a discrete number of possible values. Although modifications are very important for their value in device applications, mixing and doping solid inorganic materials requires high-temperature and rather sophisticated methods. In contrast, organic molecules have a wide variety of possible values and can be synthesized, modified, or combined with other materials to generate desired properties. As a result, organic semiconductor materials have become an increasingly popular replacement for inorganic semiconductors in LEDs. Displays technology is a field where organic LEDs (OLEDs) have been particularly successful; devices made from small molecules (SMOLEDs) as well as conjugated polymers (PLEDs) appear to be strongly competitive in performance with the more established single-crystalline semiconductor LED technology.

The use of organic electroluminescent compounds as the active component in OLEDs is well known, particularly in displays technology. Small organic molecules such as anthracene, thiadiazole derivatives, and coumarin derivatives are known to show electroluminescence. Several classes of luminescent polymers have also been disclosed, including poly(1,4-phenylene vinylene) and its derivatives, polythiophenes, especially, poly(3-alkylthiophenes), and poly(p-phenylenes). Alkyl and dialkyl derivatives of polyfluorene that are luminescent have also been disclosed, as in U.S. Pat. No. 5,708,130 and U.S. Pat. No. 5,900,327.

Unfortunately, the number and purity of colors generated by the organic light emitting compositions and compounds currently available for OLEDs is limited, particularly with respect to red and blue light emitting materials. However, organic semiconductor materials with new and desirable optical or electrical properties can be generated using a number of processes known in the art, including chemical synthesis, chemical modification or derivitization, combining organic semiconductor materials with other types of materials, and combinations thereof.

Blending is a technique known in polymer technology that takes advantage of the processibility of polymers to produce new solid materials or composites with specific structural and physical properties distinct from those of their components (E. Moons, J. Phys. Condens. Matter 14 (2002) 12235). Blending two or more polymers to create a material with properties beyond those achievable with a single polymer has become a major emphasis of polymer science. Enhanced electroluminescent (EL) efficiencies, color conversion, white light emission, polarized light emission, emission line narrowing, and voltage-tunable colors are examples of effects observed in blends containing light-emitting polymers. However, many variables are critical to achieving the desired result, including to the nature and number of components as well as the method of blending. Furthermore, although such properties might also be achieved synthetically, for example, by preparing new polymers, copolymers, derivatives, or compositions of organic materials, synthetic polymer chemistry approaches often require significantly more time and resources to develop and the materials can inherently be more expensive to produce.

Thus there is a continuing need in the field of display technology for new organic semiconducting materials and compositions, and for the processes for preparing them.

### SUMMARY OF THE INVENTION

There is provided a new semiconducting composition comprising a guest material and an active organic light emitting host material, wherein:
(a) the guest material, when used alone, has a first emission profile and a first onset emission wavelength;
(b) the light emitting host material, when used alone, has a second emission profile and a second onset emission wavelength; and
(c) the semiconducting composition has a third emission profile and a third onset emission wavelength, wherein the third emission profile and third onset emission wavelength are substantially different from the emission profiles and wavelengths of the guest and host materials when measured alone.

There is further provided a new process for preparing the new composition, including the steps of:
(a) combining a guest material and an active light emitting organic host material in at least one liquid medium, and
(b) mixing the guest material and host material, thereby producing a blended composition, wherein the emission profile and the onset emission wavelength of the composition are substantially different from the emission profiles and onset emission wavelengths of the guest and host materials when measured alone.

There is further provided a new active layer comprising the new composition.

There is further provided a new electroluminescent device having the new composition as at least one component of the light emitting material.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limited in the accompanying figures.

FIG. 1 includes electroluminescent spectra of new polymer blends where BEH-PPV is the guest and Covione PDY 132 is the host material.

FIG. 2 includes electroluminescent spectra of new polymer blends where BEH-PPV is the guest and EHOP—PPV is the host material.

FIG. 3 includes electroluminescent spectra of comparative polymer blends wherein OC1C10-PPV is the guest and EHOP-PPV is the host material.

FIG. 4 includes electroluminescent spectra of comparative polymer blends containing PDOF-DBT as the guest and Covion® PDY 132 as the host material.

FIG. 5 is a schematic diagram of an electroluminescent device that can incorporate the new semiconducting composition.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

There is provided a new composition comprising a guest material and an active organic light emitting host material, wherein:
(a) the guest material, when used alone, has a first emission profile and a first onset emission wavelength;
(b) the light emitting host material, when used alone, has a second emission profile and a second onset emission wavelength; and
(c) the semiconducting composition has a third emission profile and a third onset emission wavelength, wherein the third emission profile and third onset emission wavelength are substantially different from the emission profiles and wavelengths of the guest and host materials when measured alone.

The new semiconducting composition displays an emission profile and an onset emission wavelength that differs substantially from those of either the guest or host material alone.

Before addressing details of embodiments described below, some terms are defined or clarified.

As used herein, the term “active” when referring to a layer or material is intended to mean a layer or material having electro-radiative properties. For example, an active layer material may emit radiation or exhibit a change in concentration of electron-hole pairs when receiving radiation.

The phrase “adjacent to” when used to refer to layers in a device does not necessarily mean that one layer is immediately next to another layer. Layers that directly contact each other are still adjacent to each other.

The term “alkyl” is intended to mean a group derived from an aliphatic hydrocarbon and includes linear, branched and cyclic groups, which may be unsubstituted or substituted.

The phrase “bandwidth” is intended to mean the full width of the peak in a spectrum at half maximum intensity.

The term “band gap” is intended to mean, in a semiconductor material, the minimum energy necessary for an electron to transfer from the valence band into the conduction band, where it moves more freely.

The term “blend” is intended to mean combining two or more materials into an integrated whole including, but not limited to solutions, suspensions, dispersions, emulsions, and aggregates. Polymers may be blended using a number of methods known in the art including, but not limited to (1) dispersing one polymer in another, either as a dispersion of small particles or as a solution of one polymer in the other, or (2) placing the polymers in different liquid media and then blending the two liquids.

The term “composition” is intended to mean a material comprised of guest material and host material including, but not limited to, compositions where the guest material and host material are separate small molecules, chemically linked guest-host molecules, and combinations thereof.

The term “copolymer” is intended to mean a polymer derived from more than one species of monomer.

The term “derivative” is intended to mean a chemical substance related structurally to another substance and theoretically derivable from it. Derivatives include, but are not limited to, a substance that can be made from another substance or a substance that arises from a parent compound by replacement of one atom with another atom or group of atoms.

The phrase “emission peak” is intended to mean the wavelength at the point of maximum emission.

The phrase “emission profile” is intended to mean the light emission spectrum, including its band width and emission peaks.

The phrase “guest material” is intended to mean an organic or inorganic material which is present in a composition at less than 50% of the total composition, by weight. In one embodiment it is less than 20% by weight. Guest materials include, but are not limited to, small molecules, oligomers, polymers, organometallic compounds, and dendrimers, or combinations thereof.

The term “green” when referring to emitted light is intended to mean radiation that has a wavelength in a range of approximately 500-600 nm.

The term “homopolymer” is intended to mean a polymer derived from one species of monomer.

The phrase “host material” is intended to mean organic material which is present in a composition at greater than 50% of the total composition, by weight. In one embodiment, it is greater than 80% by weight. Host materials include, but are not limited to, small molecules, oligomers, polymers, dendrimers, organometallic compounds, and combinations thereof.

The phrase “liquid medium” is intended to mean a material that is predominantly a liquid including, but not limited to, solvents and solutions. Liquid media include, but are not limited to, organic, inorganic, and aqueous solvents and combinations thereof.

The term “material” is intended to mean the elements, constituents, or substances of which something is composed or can be made.

The term “monomeric” refers to the largest constitutional unit contributed by a single monomer molecule to the structure of a polymer or oligomer. The phrase “monomeric unit” refers to a repeating unit in a polymer or oligomer.

The term “oligomer” is intended to mean a compound comprising at least two covalently linked monomer units. Oligomers are molecules of intermediate relative molecular mass, the structure of which essentially comprises a small plurality of units derived from molecules of lower relative molecular mass. In one embodiment, oligomers are compounds having a molecular weight no greater than about 2×10³ g/mol.

The phrase “onset wavelength” is intended to mean the wavelength corresponding to 20% intensity of the emission profile, as measured from the shortest wavelength of the emission profile bisecting a line drawn through the profile at 20% intensity of the maximum emission peak.

The term “organic electronic device” is intended to mean a device including one or more semiconductor layers or materials. Organic electronic devices include, but are not limited to: (1) devices that convert electrical energy into radiation such as light-emitting diodes, light emitting diode displays, and diode lasers; (2) devices that detect signals through electronics processes such as photodetectors, photoconductive cells, photoresistors, photoswitches, phototransistors, phototubes, and IR detectors; (3) devices that convert radiation into electrical energy such as, photovoltaic devices or solar cells; and (4) devices that include one or more electronic components that contain one or more organic semi-conductor layers such as transistors or diodes.

The term “polymer” or “polymeric” is intended to mean a material having multiple repeating monomeric units, including, but not limited to, homopolymers and copolymers. Polymers are molecules of high relative molecular mass, the structure of which essentially comprises the multiple repetition of monomeric units derived from molecules of low relative molecular mass. Unsubstituted parent polymers can be modified to generate analogs including, but not limited to, unsubstituted polymers, derivatized polymers, and combinations thereof. Representative examples of polymers for the new composition include, but are not limited to, bi-substituted polymers, symmetrically-substituted polymers, symmetrically bi-substituted polymers and phenyl-substituted polymers.

The term “red” when referring to emitted light is intended to mean radiation that has an emission wavelength in a range of approximately 600-700 nm.

The term “semiconducting” is intended to mean a material with an energy gap below 3.5 eV. The energy gap for an organic material is the energy difference between the lowest unoccupied molecular orbital (LOMO) and the highest occupied molecular orbital (HOMO). The energy gap for an inorganic material is energy difference between the conduction band and the valence band.

The term “semiconductor” when referring to a material is intended to mean a material which, depending on impurity concentration(s) within the material, can be any of an insulator, a resistor, and a conductor or, when contacting a particular type of dissimilar material, can form a diode junction, or both.

The phrase “small molecule” is intended to mean a low relative molecular mass compound which does not contain repeating monomeric units. A small molecule has lower relative molecular mass than a polymer and typically has lower relative molecular mass than an oligomer.

The term “solution” is intended to mean a material dissolved or dispersed in a liquid medium including, but not limited to, solutions, blends, dispersions, aggregates, and emulsions.

The phrase “substantially different” when referring to an onset emission wavelength is intended to mean a shift in the onset emission wavelength of at least 5 nm to longer wavelength. The phrase “substantially different” when referring to an emission profile is intended to mean a significant change in at least one feature of the emission profile including, but not limited to: (1) a narrowing of the band width of the total emission profile by at least 5 nm; (2) a change in the number of peaks and areas under the peaks in the emission profile; (3) a shift in the emission peak of at least 5 nm to longer or shorter wavelength; or (4) a narrowing of the band width of the emission peak by at least 5 nm.

The “wavelength at half height” is intended to mean the wavelength at 50% maximum emission for an emission peak in the emission profile.

As used herein, the phrase “X is selected from A, B, and C” is equivalent to the phrase “X is selected from the group consisting of A, B, and C”, and is intended to mean that X is A, or X is B, or X is C.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can also be used in the practice or testing of the present invention, a number of suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Composition

The new semiconducting composition contains a guest material and an active organic light emitting host material wherein the composition has an emission profile and an onset emission wavelength that differ substantially from the emission profile and onset emission wavelength of the guest or host materials when used alone. The amount of guest material present should be sufficient to quench the luminescence of host material in order to get pure emission. In one embodiment, the blend composition contains from about 0.01 wt % to 20 wt % of guest material, based on the weight of the host material. In one embodiment, from 0.01 wt % to 10 wt %. In one embodiment, from 2 wt % to 8 wt %.

In one embodiment, the guest material is substituted. In one embodiment, the guest material is bi-substituted. Examples of guest materials useful in the new composition include, but are not limited to, poly(2,5-bis(2′-ethylhexyloxy)-1,4-phenyllenvinylene (BEH-PPV), poly([2-methoxy-5(3,7-dimethyloctyloxy)-1,4-phenylenvinylene (OC1C10-PPV), and combinations thereof. In one embodiment, the guest material is symmetrically bi-substituted. In one embodiment, the guest material is BEH-PPV. The BEH-PPV polymer contains repeating monomeric units shown in Formula A below. The OC1C10-PPV polymer contains repeating monomeric units shown in Formula B below:

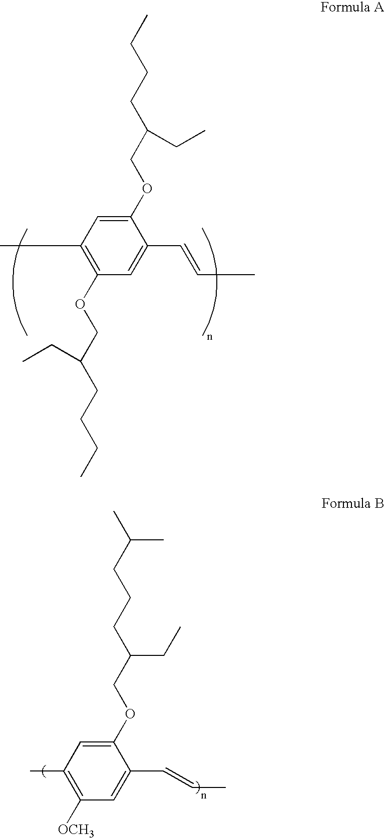

In another embodiment, the host material is substituted. In one embodiment, the host is phenyl-substituted. In one embodiment, the phenyl-substituted host material is selected from poly(p-phenylenevinylene) (PPV) and its copolymer poly(alkoxyphenylphenylvinylene-co-alkoxyphenylenevinylene), and polyfluorene and its copolymers. In one embodiment, the host material is the green emitter poly(alkylphenylphenylenevinylene). Representative examples of suitable PPV derived host materials include, but are not limited to, poly(2-(2′-ethylhexyloxy)-5-phenyl-1,4-phenylenevinylene) (EHOP-PPV) and Covion® PDY 132. Suitable polyfluorene host polymers include, but are not limited to, poly(9,9-dialkylfluorene) or its copolymers (M. Inbasekaran, W. Wu, and M. T. Bernius, W0046321A1; M. Inbasekaran, W. Wu, and E. P. Woo, U.S. Pat. No. 5,777,070).

In one embodiment, the semiconducting composition has an emission profile of from about 600 nm to 700 nm and an emission peak of from about 610 nm to 650 nm and includes (1) BEH-PPV which, when used alone, emits an orange color and has an emission profile of from about 520 nm to 700 nm and an emission peak of from about 570 nm to 590 nm, and (2) a host polymer which, when used alone, has an emission profile of from about 450 nm to 700 nm and an emission peak of from about 500 nm to 560 nm.

In one embodiment, the semiconducting composition has an emission profile of from about 550 nm to 700 nm and an emission peak of from about 560 nm to 620 nm and includes (1) OC1C10-PPV which, when used alone, emits an orange-red color and has an emission profile of from about 520 nm to 800 nm and an emission peak of from about 570 nm to 600 nm, and (2) a host polymer which, when used alone, has an emission profile of from about 450 nm to 700 nm and an emission peak of from about 500 nm to 560 nm.

In a further embodiment, there is an active layer of material containing the new composition.

In yet another embodiment, there is an organic electronic device comprising the new semiconducting composition. In one embodiment, the device is an electroluminescent device. In one embodiment, the device is a light emitting diode.

Process

The new composition can be prepared by
(a) combining a guest material and an active light emitting organic host material in at least one liquid medium, and
(b) mixing the guest material and host material, thereby producing a blended composition, wherein the emission profile and the onset emission wavelength of the composition are substantially different from the emission profiles and onset emission wavelengths of the guest and host materials when measured alone.

In one embodiment, the method for preparing the new composition includes the steps of: (a) forming a host material solution comprising an active light emitting material; (b) forming a guest material solution; and (c) combining the host material solution and the guest material solution.

In one embodiment, the guest material solution and host solution are prepared with the same solvent.

Useful solvents for making guest solution and host solution can be any solvent that dissolves or disperses the guest or host material, as the case may be, but does not chemically degrade the component material. Suitable solvents include both water-soluble and organic solvents and include, but are not limited to toluene, p-xylene, xylenes, chlorobenzene, tetrahydrofuran, dioxane and chloroform. The combined guest-host solution can be achieved at a temperature of from about room temperature up to 50° C. for a time sufficient to obtain a uniform blend, for example for a few hours.

The resulting product is a physical blend of the host material and guest material, as shown by the transmission spectra in the visible and infrared ranges.

In another embodiment, the semiconducting solution prepared as described is deposited as a light emitting layer for use in an electroluminescent device. A light emitting layer can be formed using any liquid deposition technique including, but not limited to, continuous deposition techniques such as spin coating, gravure coating, curtain coating, dip coating, slot-die coating, spray-coating, and continuous nozzle coating; and discontinuous deposition techniques such as ink jet printing, gravure printing, and screen printing.

In another embodiment, the light-emitting layer can be formed by a vapor co-deposition process, provided that the materials have the appropriate physical properties to allow for vapor deposition. Any known vapor deposition technique can be used, including physical vapor deposition and chemical vapor deposition.

In another embodiment, the light-emitting layer can be formed by a thermal transfer process.

Electroluminescent Device

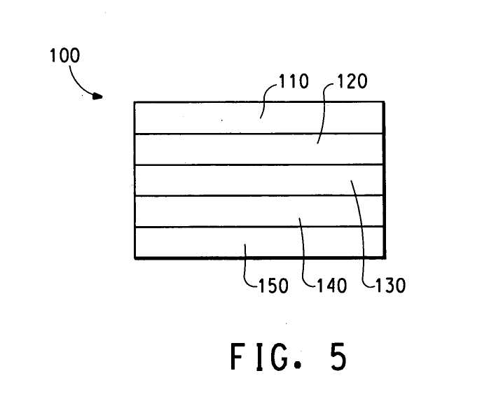

There is also provided an electroluminescent device comprising at least one active layer positioned between two electrical contact layers, wherein at least one of the active layers of the device includes the new composition. As shown in FIG. 5, a typical device 100 has an anode layer 110 and a cathode layer 150 and active layers 120, 130 and optionally 140 between the anode 110 and cathode 150. Adjacent to the anode is a hole injection/transport layer 120. Adjacent to the cathode is an optional layer 140 comprising an electron transport material. Between the hole injection/transport layer 120 and the cathode (or optional electron transport layer) is the light-emitting layer 130. The new semiconducting composition can be useful in the light-emitting layer 130.

The device generally also includes a substrate (not shown) which can be adjacent to the anode or the cathode. Most frequently, the support is adjacent the anode. The support can be flexible or rigid, organic or inorganic. Generally, glass or flexible organic films are used as a support. The anode 110 is an electrode that is particularly efficient for injecting or collecting positive charge carriers. The anode is preferably made of materials containing a metal, mixed metal, alloy, metal oxide or mixed-metal oxide. Suitable metals include the Group 11 metals, the metals in Groups 4, 5, and 6, and the Group 8-10 transition metals. If the anode is to be light-transmitting, mixed-metal oxides of Groups 12, 13 and 14 metals, such as indium-tin-oxide, are generally used. The IUPAC numbering system is used throughout, where the groups from the Periodic Table are numbered from left to right as 1-18 (CRC Handbook of Chemistry and Physics, 81^{st} Edition, 2000). The anode 110 may also comprise an organic material such as polyaniline (G. Gustafsson, Y. Cao, G. M. Treacy, F. Klavetter, N. Colaneri, and A. J. Heeger, Nature 357 (1992)477.

The anode layer 110 is usually applied by a physical vapor deposition process or spin-cast process. The term “physical vapor deposition” refers to various deposition approaches carried out in vacuo. Thus, for example, physical vapor deposition includes all forms of sputtering, including ion beam sputtering, as well as all forms of vapor deposition such as e-beam evaporation and resistance evaporation. A specific form of physical vapor deposition which is useful is rf magnetron sputtering.

Suitable materials useful in layer 120 facilitate hole injection/transport and include N,N′-diphenyl-N,N′-bis(3-methylphenyl)-[1,1′-biphenyl]-4,4′-diamine (TPD) and bis[4-(N,N-diethylamino)-2-methylphenyl](4-methylphenyl)methane (MPMP), and hole transport polymers such as polyvinylcarbazole (PVK), (phenylmethyl)polysilane, poly(3,4-ethylenedioxythiophene) (PEDOT), and polyaniline (PANI); electron and hole transporting materials such as 4,4′-N,N′-dicarbazole biphenyl (BCP); or light-emitting materials with good electron and hole transport properties, including chelated oxinoid compounds such as tris(8-hydroxyquinolato)aluminum (Alq₃).

The hole injection/transport layer 120 can be applied using any conventional means, including vapor deposition, liquid deposition, and thermal transfer patterning.

In general, the inorganic anode and the hole injection/transport layer 120 will be patterned. It is understood that the pattern may vary as desired. The layers can be applied in a pattern by, for example, positioning a patterned mask or photoresist on the first flexible composite barrier structure prior to applying the first electrical contact layer material. Alternatively, the layers can be applied as an overall layer and subsequently patterned using, for example, a photoresist and wet chemical etching. The hole injection/transport layer can also be applied in a pattern by ink jet printing, lithography or thermal transfer patterning. Other processes for patterning that are well known in the art can also be used.

The electroluminescent (EL) layer 130 is a light-emitting layer that is activated by an applied voltage (such as in a light-emitting diode or light-emitting electrochemical cell) when sufficient bias voltage is applied to the electrical contact layers. The new semiconducting composition may be used in the light-emitting layer 130.

The electroluminescent layer 130, including the new semiconducting composition can be applied from solution using any conventional liquid deposition means. The active organic materials in the EL layer can also be applied directly by vapor co-deposition processes, depending upon the nature of the materials. One can similarly apply an active oligomer precursor layer and then convert the oligomeric precursor to the polymer, typically by heating. Useful polymers include, but are not limited to, substituted, unsubstituted, or symmetrical polymers, or combinations thereof. Useful copolymers include, but are not limited to, alternating and random copolymers.

The cathode 150 is an electrode that is particularly efficient for injecting or collecting electrons or negative charge carriers. The cathode can be any metal or nonmetal having a lower work function than the first electrical contact layer (in this case, an anode). Materials for the second electrical contact layer can be selected from alkali metals of Group 1 (e.g., Li, Cs), the Group 2 (alkaline earth) metals, the Group 12 metals, the rare earths, the lanthanides, and the actinides. Materials such as aluminum, indium, calcium, barium, and magnesium, as well as combinations, can be used.

The cathode layer 150 is usually applied by a physical vapor deposition process. In general, the cathode layer will be patterned, as discussed above in reference to the anode layer 110 and conductive polymer layer 120. Similar processing techniques can be used to pattern the cathode layer.

Optional layer 140 can function both to facilitate electron transport, and also serve as a buffer layer or confinement layer to prevent quenching reactions at layer interfaces. In one embodiment, this layer promotes electron mobility and reduces quenching reactions. Examples of electron transport materials for optional layer 140 include metal chelated oxinoid compounds, such as tris(8-hydroxyquinolato)aluminum (Alq₃), phenanthroline-based compounds such as 2,9-dimethyl-4,7-diphenyl-1,10-phenanthroline (DDPA) or 4,7-diphenyl-1,10-phenanthroline (DPA), and azole compounds such as 2-(4-biphenylyl)-5-(4-t-butylphenyl)-1,3,4-oxadiazole (PBD) and 3-(4-biphenylyl)-4-phenyl-5-(4-t-butylphenyl)-1,2,4-triazole (TAZ).

It is known to have other layers in organic electroluminescent devices. For example, there can be a layer (not shown) between the conductive polymer layer 120 and the active layer 130 to facilitate positive charge transport and/or band-gap matching of the layers, or to function as a protective layer. Similarly, there can be additional layers (not shown) between the active layer 130 and the cathode layer 150 to facilitate negative charge transport and/or band-gap matching between the layers, or to function as a protective layer. Layers that are known in the art can be used. In addition, any of the above-described layers can be made of two or more layers. Alternatively, some or all of inorganic anode layer 110, the conductive polymer layer 120, the active layer 130, and cathode layer 150, may be surface treated to increase charge carrier transport efficiency. The choice of materials for each of the component layers is preferably determined by the goal of providing a device with high device efficiency.

The device 100 can be prepared by sequentially depositing the individual layers on a suitable substrate. Substrates such as glass and polymeric films can be used. In most cases the anode is applied to the substrate and the layers are built up from there. However, it is possible to first apply the cathode to a substrate and add the layers in the reverse order. In one embodiment, the different layers will have the following range of thicknesses: inorganic anode 110, 500-5000 Å, in one embodiment 1000-2000 Å; conductive polymer layer 120, 50-2500 Å, in one embodiment 200-2000 Å; light-emitting layer 130,10-1000 Å, in one embodiment 100-800 Å; optional electron transport layer 140, 50-1000 Å, in one embodiment 200-800 Å; cathode 150, 200-10000 Å, in one embodiment 300-5000 Å.

### EXAMPLES

The following examples illustrate certain features and advantages of the present invention. They are intended to be illustrative of the invention, but not limiting. All percentages are by weight, unless otherwise indicated. Emission profiles were measured with a charge coupled device (CCD) spectragraph.

### Example 1

An EL device containing an active layer with the new composition was constructed in the following manner:
(a) a transparent anode of indium tin oxide coated on glass was provided by Applied Materials (Santa Clara, Calif.). The indium tin oxide (ITO) was about 1500 Angstroms thick and the glass was 0.7-1.1 mm thick. Prior to use, the ITO substrate was cleaned in sequence by acetone, detergent, deionized (DI) water and isopropanol followed by heating at 80-90° C. in vacuum oven. The substrates were further treated with oxygen plasma immediately before the next step;
(b) an aqueous dispersion containing poly(3,4-ethylenedioxythiophene) (PEDOT) and poly(styrenesulfonate) (PSS)[PEDOT/PSS; Bayer Baytron® P] or polyaniline (PANI) and poly(acrylamidomethylpropane sulfonic acid) (PAAMPSA) (PANI/PAAMPSA) was deposited onto the ITO substrate by spin-coating. The spin speed was about 1000-4000 rpm. The thickness of this buffer layer was 500-3000 Angstroms. PANI-PAAMPSA was prepared by agitating an aqueous solution of aniline, PAAMPSA, and (NH₄)₂S₂O₈ for several hours followed by precipitation of product as disclosed in U.S. Publication No. U.S. 2002/0038999 and PCT Publication No. WO 01/41230.

(c) a suitable concentration of substituted poly(p-phenylenevinylene) host material doped with BEH-PPV or OC1-C10-PPV guest material was obtained by mixing different volumes of the corresponding solutions of BEH-PPV or OC1-C10-PPV in toluene, or OC1C10-PPV in p-xylene, with phenyl-substituted poly-p-phenylenevinylene host material in toluene. The resulting blend solution was stirred at room temperature for 10 hours. An emitter layer of phenyl-substituted poly(p-phenylenevinylene) host material doped with guest material BEH-PPV or guest material OC1C10-PPV was subsequently spin cast on the PEDOT/PSS or PANI/PMMPSA buffer layer inside a dry box. The thickness of the emitter layer was about 500-1500 Angstroms which was adjusted by spin speed; and
(d) a thin cathode layer of barium was deposited on the emitting layer. The thickness of Ba layer was 15-45 Angstroms. An Al or Ag capping layer was deposited on top of Ba layer immediately after Ba deposition. The thickness of the capping layer was about 2000-5000 Angstroms.

The IV characteristics of the EL device prepared according to this example were measured by computer-controlled Keithley source meter Model 236 and LV characteristics were recorded with a calibrated Si photodiode or in an integrating sphere. The spectral characteristics of the EL device prepared according to this example were recorded by an ORIEL Intaspec 4 CCD spectrophotometer (available from Strafford, Conn.).

### Example 2

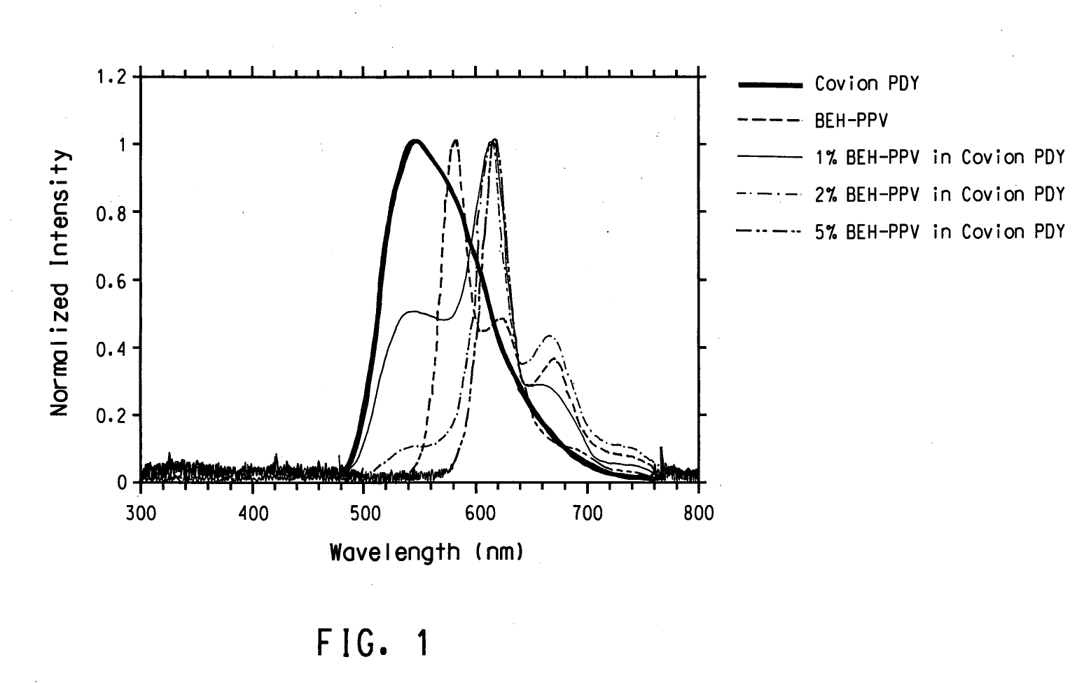

EL devices were prepared according to the procedure described in Example 1, where the commercially available green emitter Covione PDY 132 (Covion PDY) was used as the substituted poly-p-phenylenevinylene host material and BEH-PPV was used as the red emitting guest material. The ratio of BEH-PPV to Covion® PDY 132 in the emitting layer was varied from 0.5 to 5%. The EL spectra of 1, 2 and 5% of BEH-PPV in Covion® PDY 132 were compared with those of pure Covion® PDY 132 and pure BEH-PPV (onset emission wavelength about 560 nm) in FIG. 1. Without BEH-PPV, the EL spectrum shows only the green emission band arising from the substituted-PPV host material with an onset emission wavelength of about 500 nm. At a low concentration of BEH-PPV, around 1%, a significant fraction of green emission from the host (ca. 30%) can be observed and onset emission wavelength of the host has shifted to about 508 nm (c.a. 8 nm to longer wavelength). Around 2%, the host EL components became essentially insignificant. The optimal concentration is about 4-5% weight fraction of BEH-PPV in Covion® PDY 132. At this concentration, the green EL component from the substituted PPV disappeared and the EL spectra arose exclusively from the BEH-PPV emission. In addition, the onset emission wavelength of the composition has shifted about 45 nm to longer wavelength when compared to that of BEH-PPV alone. This fact is quite impressive compared to previous art disclosed in U.S. Pat. No. 5,409,783 where the small molecule red dye magnesium pthalocyanine (MgPc) was blended into the small molecule green emitter aluminum tris (8-hydroxyquinoline) (Alq3) by thermal co-deposition. The maximum emission of the red dye component therein was only 50% of total emission when MgPc was 3 wt % in the blended emitter (see FIG. 5 in U.S. Pat. No. 5,409,783). In contrast, the devices with the BEH-PPV doped green emitting host material in this example emit only red emission when the weight fraction of BEH-PPV reaches a certain level. This result indicates there is complete energy transfer of excitons created on the host material into the dopant red emitter which has a narrower band gap. At the same time, the luminance efficiency of the devices from the BEH-PPV blend in green emitting host increased dramatically to 2-4 cd/A in comparison with that from pure BEH-PPV (Table 1).

In addition to a complete energy transfer, the devices containing the BEH-PPV doped green emitter Covione PDY 132 exhibit two other new features:
a) The emission peak was red-shifted by ca. 35 nm (λₘₐₓ=580 nm for BEH-PPV and λₘₐₓ=616 nm for 2% BEH-PPV in Covion® PDY 132.(FIG. 1).
b) The emission peak changes its shape significantly. The relative intensity of the 0-1 vibration peak at around λ=670 nm decreases with the increasing BEH-PPV weight ratio in the host EL material. When the doping level of BEH-PPV reaches 5%, the emission shoulder at λ=670 nm disappears completely and the emission of 5% BEH-PPV-doped Covion® PDY 132 emitter becomes a single peak centered at λₘₐₓ=616 nm. This fact indicates that color purity of emission of polymer LEDs can be improved using this doping technique.

In the red region of the visible spectrum, the external quantum and power efficiency was significantly improved in the BEH-PPV doped device. Table 1 summarizes the external quantum and luminance efficiency for devices with different ratios of BEH-PPV to Covion® PDY 132. The BEH-PPV device shows typical QEₑₓₜ=1.0%. This value increases to as high as 4% in the blend with Covion® PDY 132 in a 2% weight ratio. Similarly, the luminance efficiency increases from 0.5 cd/A for pure BEH-PPV to more than 5 cd/A for 2% BEH-PPV in the Covion® PDY 132 device.

This example clearly indicates that by using a red-emitter doped into green emitter, both the device efficiency and the color purity improved remarkably.

### Example 3

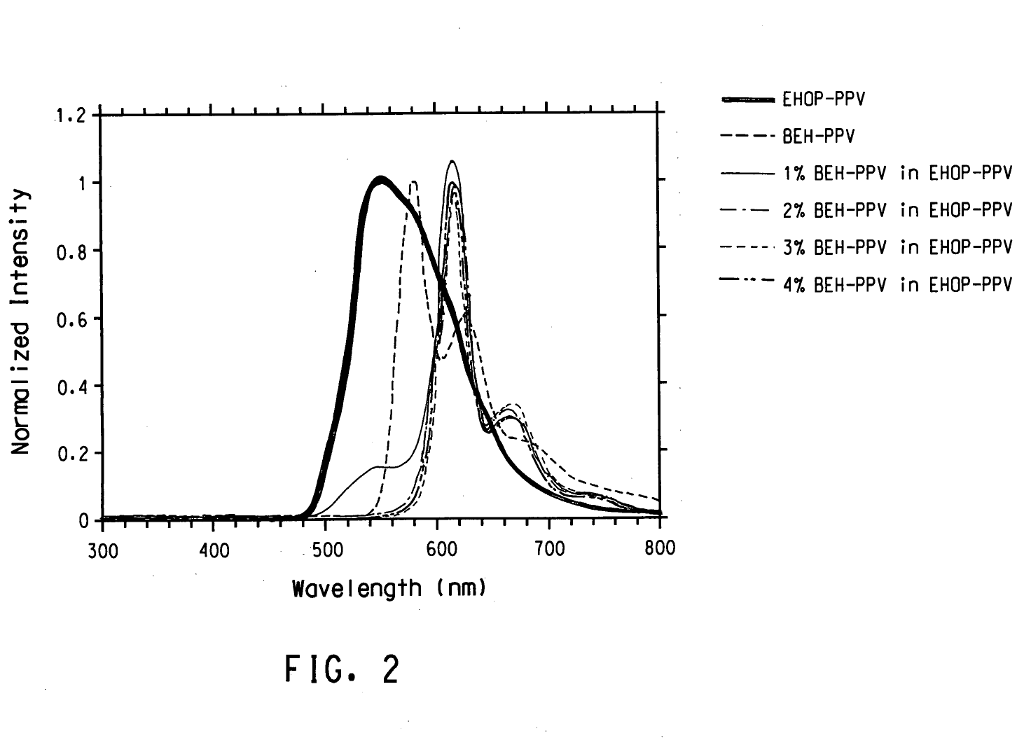

Example 2 was repeated but poly(2-(2′-ethylhexyloxy)-2-phenyl-1,4-phenylenevinylene) (EHOP-PPV), synthesized according to a procedure similar to that described in H. Spreitzer, H. Becker, E. Kluge, W. Kreuder, H. Schenk, R. Demandt, H. Schoo; Advanced Materials, 10 (1998) 1340, was used as the green emitting host material instead of Covion® PDY 132. The EL spectra are shown in FIG. 2. The luminance efficiency and quantum efficiencies of the 2 and 4% BEH-PPV doped devices are listed in Table. 1. Although the results are quite similar to those observed in case of Covion® PDY 132, EHOP—PPV generally provides better results wherein the green emission disappears above 1% BEH-PPV, the onset emission wavelength of the composition shifts about 40 nm to longer wavelength when compared to that of BEH-PPV alone. and there is no decay of power efficiency with increasing of dopant concentration. These facts indicate that the nature of the host material has a strong influence on the behavior of the device containing the doped emitter.

### Example 4

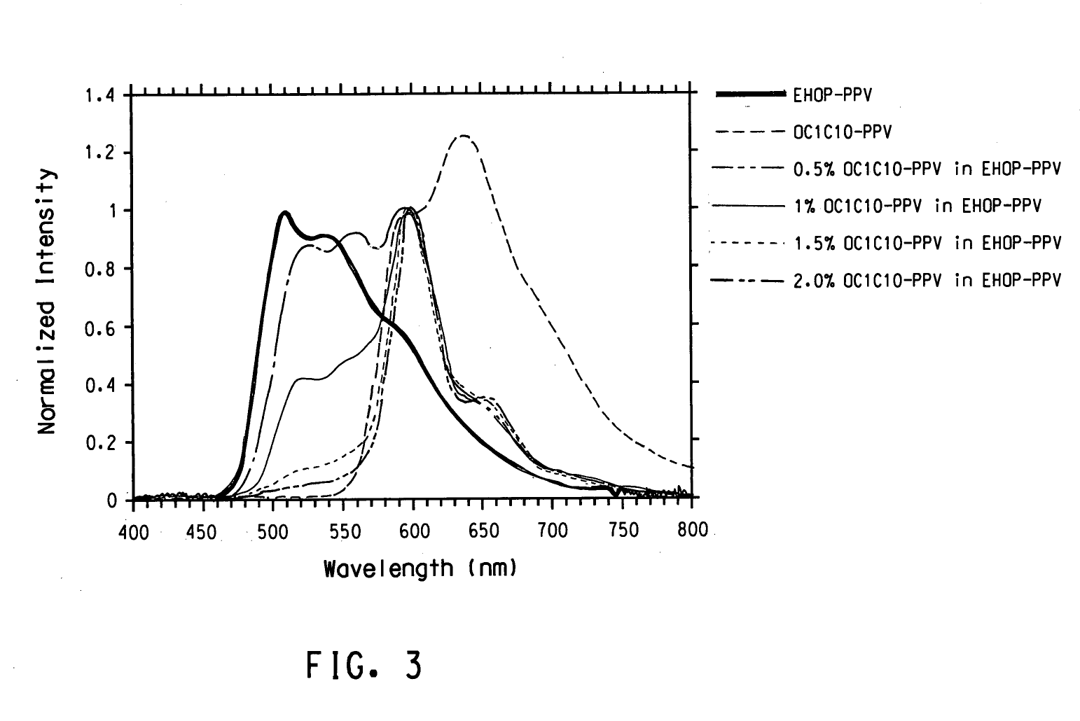

Example 2 was repeated but the red emitter, OC1C10-PPV was used in place of BEH-PPV as a red emitting dopant at doping levels of 0.5, 1.0, 1.5 and 2.0% relative to the host material. As for Example 3, the green emitter, EHOP-PPV was used as the host material in place of Covion® PDY 132. The EL spectra are shown in FIG. 3. Similar to the case of Examples 2 and 3, a significant narrowing of the emission band was observed for the doped devices due to decreasing intensity in the second vibronic peak. However, although a slight red shift for the shorter wavelength emission peak (ca. 8 nm, from about 596 nm to about 604 nm) and for the onset emission wavelength (ca. 5 nm, from about 567 nm to about 673 nm,) in pure OC1C10-PPV was observed in the OC1C10-PPV doped device, it is less significant than in the case of Example 2. The quantum efficiencies of the OC₁-C10-PPV doped devices are listed in Table 1. This example clearly indicates that the observed color tuning is dependent on the choice of guest materials.

### Comparative Example 1

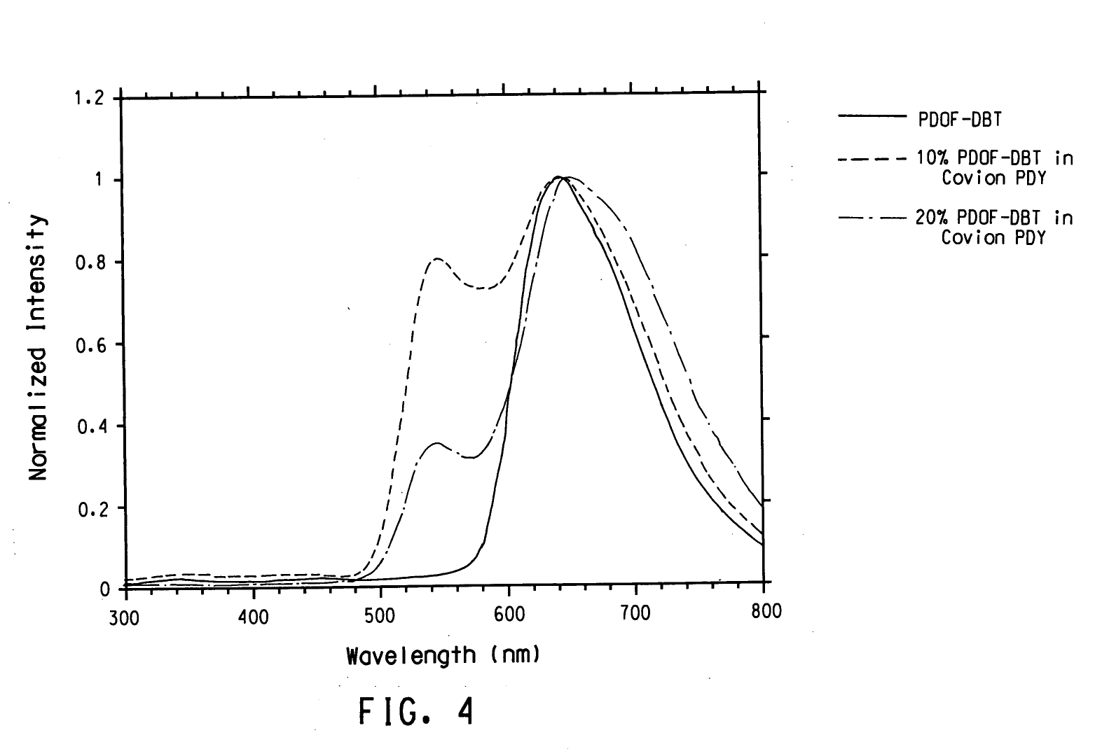

Example 2 was repeated, but the red polyfluorene copolymer emitter (poly(9,9-dioctylfluorene-co-4,7-dithienyl-2-yl-2,1,3-benzothiadiazole (PDOF-DBT) was used as a guest material in place of BEH-PPV. The PDOF-DBT was prepared by copolymerization of fluorene and benzothiadiazole via Suzuki cross-coupling reaction under Pd catalyst using THF cosolvent as described in U.S. Pat. No. 5,777,070, U.S. Pat. No. 6,353,083 and PCT Publication No. WO 00/46321. The EL spectra are shown in FIG. 4. As can be seen from FIG. 4, even at dopant loading as high as 20%, the host emission (peak 520-530 nm) remained. This fact indicates that energy transfer from the host material to PDOF-DBT is much less efficient than for the case described in Examples 3 and 4 since there was almost no red shift in the emission spectrum of the guest material in the doped device. This Example further indicates that the observed tuning of color is dependent on the choice of guest materials for a given host material.

TABLE 1
Device performance from BEH-PPV and OC1C10-PPV in polymer blends

| Device | | | weight fraction(%)* | EL efficiency(%)** | |
|---|---|---|---|---|---|
| ID | Guest | Host | of guest | QE (%) | cd/A |
| 1 | BEH-PPV | — | 100 | 1.0 | 0.5 |
| 2 | — | Covion ® PDY | 0 | 3.6 | 8.4 |
| 3 | BEH-PPV | Covion ® PDY | 1 | 3.7 | 5.7 |
| 4 | BEH-PPV | Covion ® PDY | 2 | 4.1 | 5.6 |
| 5 | BEH-PPV | Covion ® PDY | 5 | 2.7 | 4.3 |
| 6 | BEH-PPV | EHOP-PPV | 2 | 3.7 | 4.7 |
| 7 | BEH-PPV | EHOP-PPV | 4 | 3.4 | 5.3 |
| 8 | | EHOP-PPV | 0 | 1.0 | |
| 9 | OC1C10-PPV | | 100 | 2.0 | |
| 10 | OC1C10-PPV | EHOP-PPV | 0.5 | 0.7 | |
| 11 | OC1C10-PPV | EHOP-PPV | 1.0 | 1.1 | |
| 12 | OC1C10-PPV | EHOP-PPV | 1.5 | 1.7 | |
| 13 | OC1C10-PPV | EHOP-PPV | 2.0 | 2.1 | |

*based on the weight of the host
**measured at a current density of 35 mA/cm² in integrating sphere

What is claimed is:

1. A semiconducting composition comprising a guest material and an active organic light emitting host material, wherein:
(a) the guest material, when used alone, has a first emission profile and a first onset emission wavelength;
(b) the light emitting host material, when used alone, has a second emission profile and a second onset emission wavelength; and
(c) the semiconducting composition has a third emission profile and a third onset emission wavelength, wherein the third emission profile and third onset emission wavelength are substantially different from the emission profiles and wavelengths of the guest and host materials when measured alone.

2. The composition of claim 1, wherein the guest material comprises from 0.01 wt % to about 20 wt %, based on the weight of the host material.

3. The composition of claim 2, wherein the guest material comprises from 0.01 wt % to 10 wt %, based on the weight of the host material.

4. The composition of claim 3, wherein the guest material comprises from 2 wt % to 8 wt %, based on the weight of the host material.

5. The composition of claim 1, wherein the guest material is substituted.

6. The composition of claim 5, wherein the guest material is symmetrically bi-substituted.

7. The composition of claim 5, wherein the guest material comprises a material selected from BEH-PPV, OC1C10-PPV, and combinations thereof.

8. The composition of claim 1, wherein the host material is phenyl-substituted.

9. The composition of claim 8, wherein host material comprises a material selected from poly(alkyphenylphenylvinylene), poly(alkyphenylphenylvinylene-co-alkoxyphenylenevinylene), polyfluorene, polyfluorene copolymers, and combinations thereof.

10. The composition of claim 9, wherein the host material comprises poly(alkylphenylphenylenevinylene).

11. The composition of claim 1, wherein the guest material and host material are chemically linked.

12. The composition of claim 1, wherein the composition is a copolymer comprising monomeric units of guest material and host material.

13. An active layer comprising the composition of claim 1.

14. An organic electronic device comprising the composition of claim 1.

15. The device of claim 14, wherein the composition emits red light.

16. The device of claim 15, wherein the guest material comprises a material selected from BEH-PPV, OC1C10-PPV, and a combination thereof.

17. The device of claim 16, wherein the device has an emission profile of from about 550 nm to 700 nm and an emission peak of from about 560 nm to 650 nm.

18. A method for producing the semiconducting composition of claim 1 comprising:
a) combining a guest material and an active light emitting organic host material in at least one liquid medium, and
(b) mixing the guest material and host material, thereby producing a blended composition, wherein the emission profile and the onset emission wavelength of the composition are substantially different from the emission profiles and onset emission wavelengths of the guest and host materials when measured alone.

19. The method of claim 18, wherein the process for combining the guest material and host material comprises:
(a) forming a host material solution comprising an active light emitting material and a first liquid medium;
(b) forming a guest material solution comprising a guest material and a second liquid medium; and
(c) combining the host material solution and the guest material solution.

20. The method of claim 18, wherein the guest material comprises from 0.01 wt % to 20 wt %, based on the weight of the host material.

21. An active layer comprising a composition made by the method of claim 18.

22. An organic electronic device comprising a composition made by the method of claim 18.
